(19) United States
(12) Patent Application Publication
(10) Pub. No.: US 2015/0254011 A1
(43) Pub. Date: Sep. 10, 2015

(54) MEMORY SYSTEM, MEMORY CONTROLLER AND CONTROL METHOD OF NON-VOLATILE MEMORY

(71) Applicant: Kabushiki Kaisha Toshiba, Minato-ku (JP)

(72) Inventor: Katsuhiko UEKI, Katsushika (JP)

(73) Assignee: Kabushiki Kaisha Toshiba, Minato-ku (JP)

(21) Appl. No.: 14/482,806

(22) Filed: Sep. 10, 2014

Related U.S. Application Data
(60) Provisional application No. 61/950,543, filed on Mar. 10, 2014.

(51) Int. Cl. G06F 3/06

(52) U.S. Cl. CPC G06F 3/0619; G06F 3/0688; G06F 3/0652

(57) ABSTRACT

According to an embodiment, a controller executes chip interleaving for a host write partway through one cycle, and executes chip interleaving for writes of garbage collection to n memory chips from a memory chip next in turn to a memory chip to which the host write was executed last, to the memory chip to which the host write was executed last.

### CROSS-REFERENCE TO RELATED APPLICATIONS

This application is based upon and claims the benefit of priority from U.S. Provisional Patent Application No. 61/950543, filed on Mar. 10, 2014; the entire contents of which are incorporated herein by reference.

### FIELD

Embodiments described herein relate generally to a memory system including a non-volatile memory, a memory controller, and a control method of a non-volatile memory.

### BACKGROUND

In a storage device using flash memory, parallel processing called bank interleaving is executed. Bank interleaving allows a high-speed process by causing a plurality of memory chips connected to one common IO bus to execute an interleaving operation. The plurality of memory chips belongs to different banks.

In such a storage device, a write process is executed on the flash memory mainly when a write request is received from a host or when garbage collection is executed, the garbage collection being an internal process of the storage device.

In scheduling of bank interleaving, the order of writes between banks is determined for the time when data from the host is written and the time when a write is executed for garbage collection. An increase in the usage ratio of a plurality of banks is important to increase the write speed. Hence, such scheduling of bank interleaving as to increase the usage ratio of the plurality of banks as high as possible is desired.

### BRIEF DESCRIPTION OF THE DRAWINGS

FIG. 1 is a functional block diagram illustrating an internal configuration of a memory system;

FIG. 2 is a diagram illustrating scheduling in a first comparative example;

FIG. 3 is a diagram illustrating scheduling in a second comparative example;

FIG. 4 is a diagram illustrating an example of scheduling in a first embodiment;

FIG. 5 is a diagram illustrating an example of scheduling in the first embodiment;

FIG. 6 is a diagram illustrating an example of scheduling in the first embodiment;

FIG. 7 is a flowchart illustrating a control procedure for scheduling in the first embodiment; and

FIG. 8 is a diagram illustrating an example of scheduling in a second embodiment.

### DETAILED DESCRIPTION

In general, according to one embodiment, a memory system includes a non-volatile memory and a controller. The non-volatile memory includes n (n≧2) memory chips, the memory chips sharing a bus, each of the memory chips including a plurality of blocks, each of the blocks being a unit of data erasing, each of the blocks including a plurality of memory cells. The controller is configured to execute a first write and a second write by executing chip interleaving for a plurality of cycles, the chip interleaving being executed by accessing the n memory chips in a predetermined order, the first write being for writing data received from a host to the memory chip, the second write being for collecting valid data read from a first block of the memory chip and writing the valid data to a second block of the memory chip. the controller is configured to execute, partway through one cycle, the chip interleaving for the first write, and execute the chip interleaving for the second write to the n memory chips from a memory chip next in turn to a memory chip to which the first write was executed last, to the memory chip to which the first write was executed last.

Exemplary embodiments of the memory system, the memory controller, and a control method of the non-volatile memory will be explained below in detail with reference to the accompanying drawings. The present invention is not limited to the following embodiments.

### First Embodiment

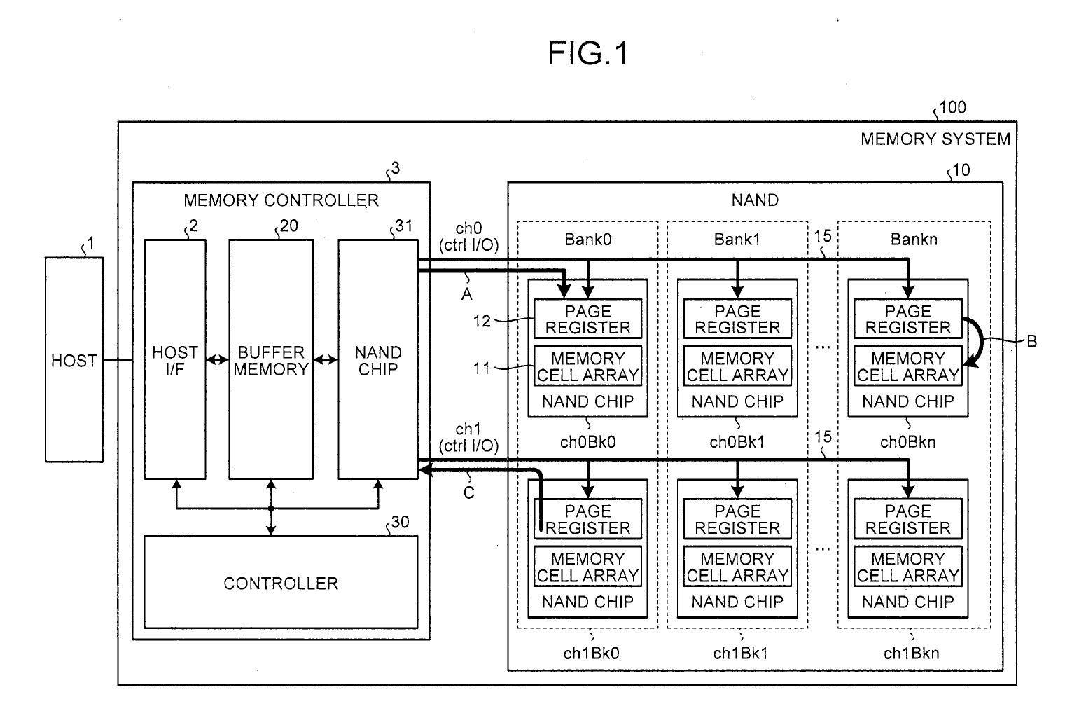

FIG. 1 illustrates a configuration example of an SSD (Solid State Drive) 100 being an example of the memory system. The SSD 100 is connected to a host apparatus (hereinafter abbreviated as the host) 1 via a host interface 2, and functions as an external storage device of the host 1. The host 1 is, for example, a personal computer, a mobile phone, or an imaging apparatus.

The SSD 100 includes a NAND flash 10 (hereinafter abbreviated as the NAND) as a non-volatile semiconductor memory, and a memory controller 3. The memory controller 3 includes the host interface 2, a NAND controller (NANDC) 31, a buffer memory 20, and a controller 30. The non-volatile semiconductor memory can be another memory such as a ReRAM (Resistance Random Access Memory).

The NAND 10 stores user data, the management information of the user data that is transmitted from the host 1, system data, and the like. The NAND 10 includes a plurality of memory chips (NAND chips) Ch0Bk0, Ch0Bk1, Ch0Bkn, Ch1Bk0, Ch1Bk1, . . . and Ch1Bkn. The plurality of NAND chips included in the NAND 10 executes a bank parallel operation and a channel parallel operation.

One channel includes one control I/O bus (Ctrl I/O) 15 and the plurality of NAND chips sharing one Ctrl I/O bus 15. The channel parallel operation is achieved by operating a plurality of channel components in parallel.

In the case of FIG. 1, there are two channels (ch0 and ch1). The NAND 10 may have one channel configuration.

The plurality of (n) NAND chips sharing one Ctrl I/O bus 15 performs an interleaving operation to achieve the bank parallel operation. The bank is configured by selecting the NAND chips one by one from each channel. In other words, the number of banks corresponds to the number of NAND chips sharing the Ctrl I/O bus 15. In the case of FIG. 1, there are n banks (Bank 0, Bank 1, . . . , and Bank n), and a plurality of NAND chips belong to the same bank executes the channel parallel operation.

Each NAND chip includes a memory cell array 11 where a plurality of memory cells is arranged in matrix form, and a page register (page buffer) 12. The page register 12 buffers one page of write data to or read data from the memory cell array 11. Each memory cell is capable of multilevel storage. The memory chip is configured by arranging a plurality of physical blocks, each of the physical blocks being a unit of data erasing. In the NAND 10, data writing and data reading are performed per physical page. The physical block is configured with a plurality of physical pages.

The host I/F 2 receives commands such as a read command and a write command from the host 1 via a communication interface such as an SATA (Serial Advanced Technology Attachment) and an SAS (Serial Attached SCSI). The address, size, data, and the like are added to the command. When receiving a command from the host 1, the host I/F 2 notifies the controller 30 of the command.

The buffer memory 20 temporarily stores data to be transferred between the host 1 and the NAND 10. For example, an SRAM (Static Random Access Memory) and a DRAM (Dynamic Random Access Memory) are used as the buffer memory 20.

The NANDC 31 includes, for example, a NAND I/F that performs an interface process in between with the NAND 10, an error correction circuit, and a DMA controller, and performs things such as writing to the NAND 10 data temporarily stored in the buffer memory 20, and reading out data stored in the NAND 10 to transfer the data to the buffer memory 20, based on the control of the controller 30.

The controller 30 executes a process of writing data to be written to the NAND 10, to the NAND 10 via the buffer memory 20, and a process of reading from the NAND 10. Moreover, the controller 30 executes data organization in the NAND 10, the data organization being garbage collection.

In the memory system 100, mainly when a host write or garbage collection is performed, a write process is performed on the NAND 10.

### Host Write

The host write is a data write process based on a request of the host 1. The host 1 outputs a write command, a write address, and write data to the memory system 100. The write data is buffered in the buffer memory 20 in the memory controller 3. When the write data is buffered in the buffer memory 20 to the amount of the write unit to the NAND 10, the controller 30 transfers the data to the page register 12 of the NAND chip via the NANDC 31 and the Ctrl I/O bus 15. In the data transfer, the data transfer from the NANDC 31 to the page register 12 as indicated by the arrow A is called a data-in operation. When the data-in operation is completed, a control circuit (not illustrated) in the NAND chip performs a program operation that stores the data of the page register 12 into the memory cell of the memory cell array 11 as indicated by the arrow B.

### Garbage Collection: GC

If the data erasure unit (block) and the data read/write unit are different in the memory system 100, according to the progress of rewriting of the NAND 10, the blocks are made porous by invalid data (not the latest) data. When the blocks in such a porous state increases, substantially, usable blocks decrease and a storage area of the NAND 10 cannot be effectively used. Therefore, for example, if the number of unused blocks of the NAND 10 is reduced below a predetermined threshold value, garbage collection is executed in which valid data in a GC source block is collected to be moved to a GC destination block. Accordingly, the number of unused blocks is increased. Garbage collection is hereinafter abbreviated as GC.

The data of the GC source block exists on the NAND 10. Therefore, the data is transferred by a GC read operation from the NAND chip to the buffer memory 20 in the memory controller 3. Specifically, the GC read has two stages including a page read operation and a data-out operation. In the page read operation, data is moved from the memory cell array 11 to the page register 12 in the NAND chip. In the data-out operation, data is transferred from the page register 12 in the NAND chip to the buffer memory 20 in the memory controller 3 via the Ctrl I/O bus 15 and the NANDC 31. The GC read is hereinafter described assuming to be a process including the page read operation and data transfer from the page register 12 to the NANDC 31 as indicated by the arrow C.

In GC, the data-in operation indicated by the arrow A and the program operation indicated by the arrow B are executed as in the host write after data is transferred by the read operation from the NAND chip to the buffer memory 20 in the memory controller 3.

Among the operations including both the host write and GC, the data-in operation indicated by the arrow A and the GC read indicated by the arrow C occupy the Ctrl I/O bus 15. The program process indicated by the arrow B, however, does not use the Ctrl I/O bus 15. The program process does not occupy the Ctrl I/O bus 15. Accordingly, the parallel operation is possible between the plurality of NAND chips sharing the Ctrl I/O bus 15 with respect to the program process. It can also be said that bank interleaving is to cause the plurality of NAND chips sharing the Ctrl I/O bus 15 to operate the program process in parallel.

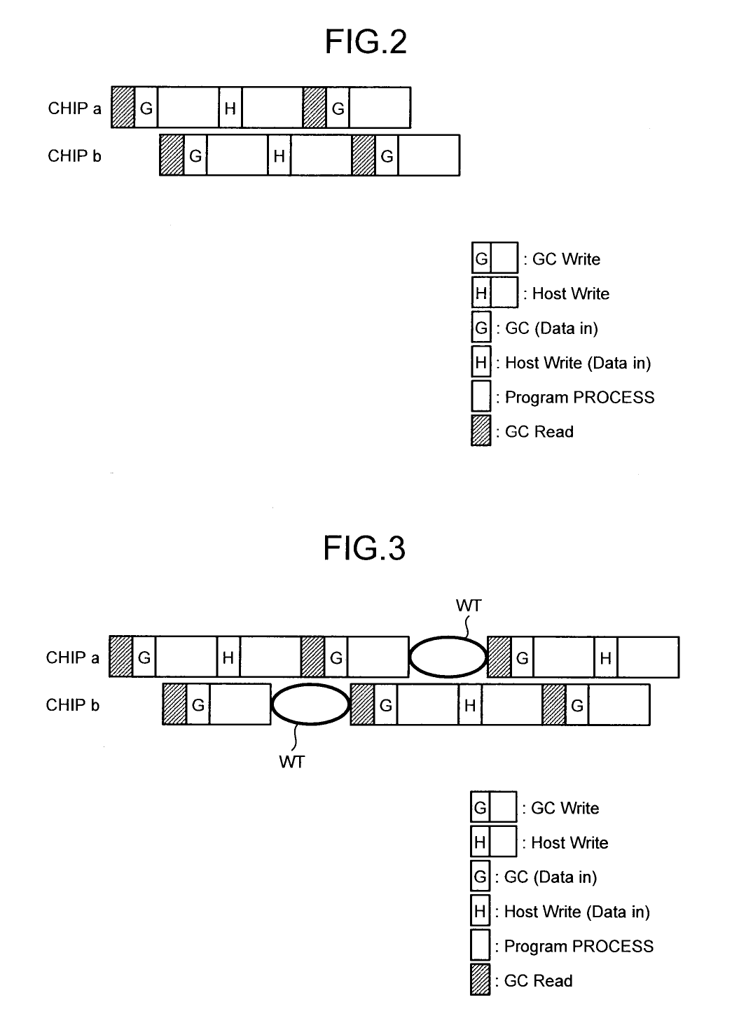

FIG. 2 illustrates scheduling for two bank interleaving in a first comparative example. In the first comparative example, the interleaving operation is performed on chips a and b that share the Ctrl I/O bus 15. In FIG. 2, the interleaving operation from the chips a to b is performed for three cycles. In the first comparative example, upon the interleaving operation, writes for both the host write and garbage collection are always performed in the order of a, b, a, b, . . . . In other words, in the first comparative example, GC is performed first in the order of the chips a and b. The host write is then performed in the order of the chips a and b. Next, GC is performed in the order of the chips a and b.

In the case of the first comparative example illustrated in FIG. 2, when the interleaving operation for the host write is performed, two pages' worth of write data to a page of the chip a and write data to a page of the chip b needs to be prepared. In the case of FIG. 2, two pages' worth of data for the host writes is prepared and accordingly the interleaving operation for the host writes can be performed without the wasted time. However, if, for example, only one page worth of data for the host write can be prepared in the first comparative example, the wasted time occurs after the data-in operation of the host write for the chip a. Moreover, in the case of the first comparative example, a large buffer amount to secure data for the host write is required to perform the interleaving operation with little wasted time.

FIG. 3 illustrates scheduling for two bank interleaving in a second comparative example. In the case of the second comparative example, if data for the host writes cannot be prepared for all the chips, GC is inserted. In the case of FIG. 2, only one page worth of data for the host write can be prepared. Accordingly, the host write is performed on the chip a, and then GC is performed in the order of the chips a and b. When GC is completed in the order of the chips a and b, one page worth of data for the host write can be prepared. Accordingly, the host write is performed on the chip b after GC. However, in the second comparative example, a large amount of wasted time WT during which the chip is not effectively used occurs, which becomes a cause of a reduction in the performance of the write speed.

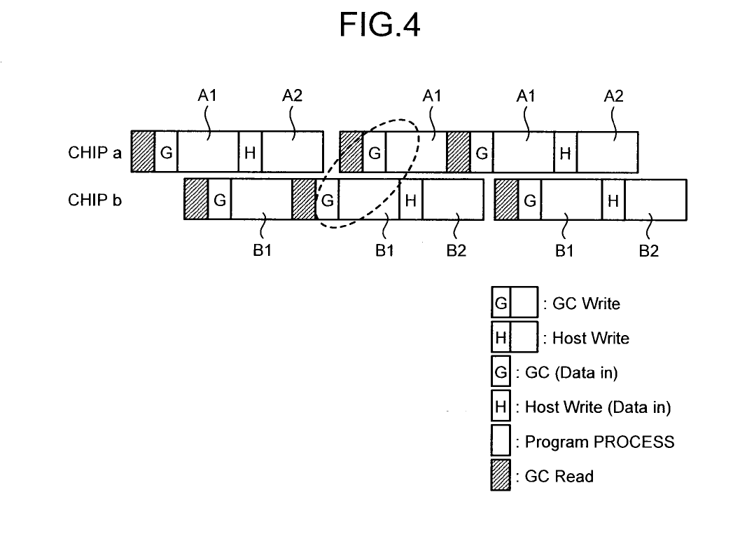

FIG. 4 is a diagram illustrating scheduling for two bank interleaving by the controller 30 in a first embodiment. In the first embodiment, two bank interleaving is performed for five cycles. The interleaving operation for GC is not limited to the order of the chips a and b but also permits the order of the chips b and a. In other words, a first chip to start a round for the interleaving operation is not limited to the chip a out of the chips a and b but also permits the chip b.

In the first embodiment, bank interleaving for the host write is executed partway through one cycle, and chip interleaving for the GC write is executed on the n memory chips from a memory chip next in turn to a memory chip to which the host write was executed last, to the memory chip to which the host write was executed last. For example, if data for the host writes cannot be prepared for all the chips, GC is first executed on a memory chip to which the unprepared data is scheduled to be written. GC is subsequently executed in the order of chips to be bank interleaved, at least until the end of a round for the memory chips. In other words, when the host write is switched to GC, GC is first performed on a chip on which the host write is scheduled to be performed next, and GC is subsequently executed in the order of chips to be bank interleaved, at least until the end of a round for the memory chips. If data for the host write cannot be prepared at the end of a round of GC, GC is executed on the memory chips for another round.

In the case of FIG. 4, only one page worth of data for the host write can be prepared. Accordingly, data-in of the host write is performed on the chip a. GC is subsequently performed on the chip b and then on the chip a as indicated by the broken line. When the data-in of GC for the chip a is completed, one page worth of data for the host write can be prepared. Accordingly, the host write is performed on the chip b after the data-in of GC. When the data-in of GC for the chip a is completed, if one page worth of data for the host write cannot be prepared, GC is further executed in the order of the chips b and a.

It is not always possible in the memory system 100 to secure host data necessary to perform the interleaving operation on the plurality of chips. In contrast, it is always possible to secure data for GC since GC is an internal process. Hence, in the first embodiment, if data for the host writes cannot be prepared for all the chips, GC is executed on a memory chip to which the unprepared data is scheduled to be written.

The data to be written to the NAND 10 during GC is a collection of data having low update frequency in many cases. A GC destination block should be separated from a block for the host write. Hence, also in FIG. 4, different blocks are used for a block to which data for GC is written and a block for the host write.

For example, in FIG. 2, it is assumed that GC is performed on a block A1 of the chip a and a block B1 of the chip b, and that the host write is performed on a block A2 of the chip a and a block B2 of the chip b. Focus on the chip a. Firstly, the GC write is performed on page x of the block A1. Next, the host write is performed on page y of the block A2. Next, the GC write is performed on page x+1 of the block A1. Next, the GC write is performed on page x+2 of the block A1. Next, the host write is performed on page y+1 of the block A2. Focus on the chip b. Firstly, the GC write is performed on page x of the block B1. Next, the GC write is performed on page x+1 of the block B1, and the host write is performed on page y of the block B2. Next, the GC write is performed on page x+2 of the block B1. Next, the host write is performed on page y+1 of the block B2.

In the first embodiment, if the interleaving operation for the host write is switched to one for GC partway through the interleaving operation as indicated by the broken line, GC is subsequently executed for some rounds until data for the host write can be prepared. Hence, the write destination page number of the GC block Al of the chip a can always match up to the write destination page number of the GC block B1 of the chip b. Therefore, in the first embodiment, even if inter-chip error correcting code (inter-chip ECC) is adopted, the coding process and the decoding process are not made complicated. In the inter-chip error correcting code (inter-chip ECC), redundant code is created from data distributed to and stored in a plurality of memory chips.

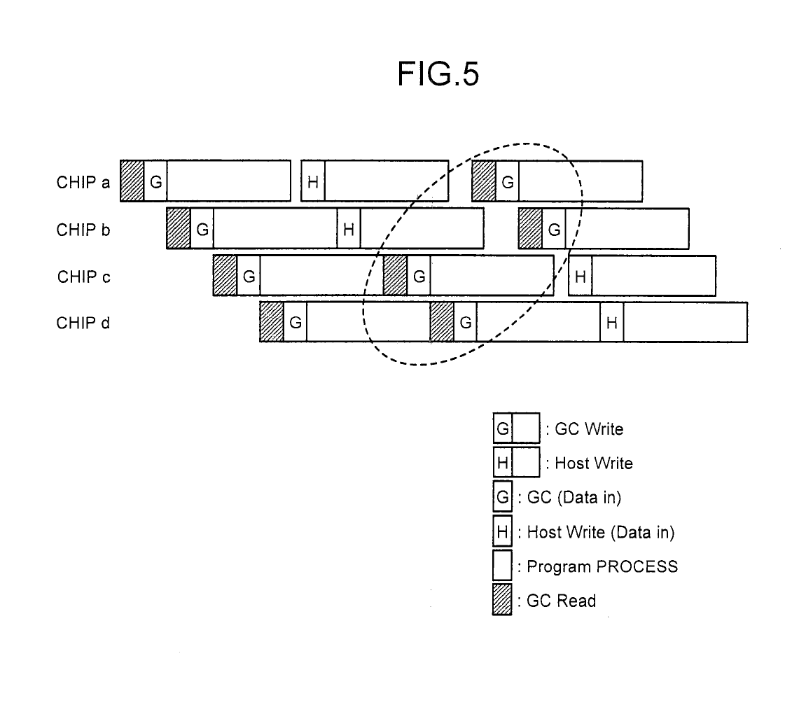

FIG. 5 is a diagram illustrating scheduling for four bank interleaving by the controller 30 in the first embodiment. In FIG. 5, after the interleaving operation for GC is performed for one round, the host writes are performed to the chips a and b. In FIG. 5, when the data-in of the host write for the chip b is completed, data for the host write to chips c and d cannot be prepared. Accordingly, the use of the write is switched from the host write to GC. GC is then performed to the chip c, and further on the chips d, a, and b. Accordingly, GC is performed for one round. In FIG. 5, when the data-in of GC for the chip b is completed, two pages' worth of data for the host writes can be prepared. Accordingly, the host writes are performed on the chips c and d after GC on the chip b.

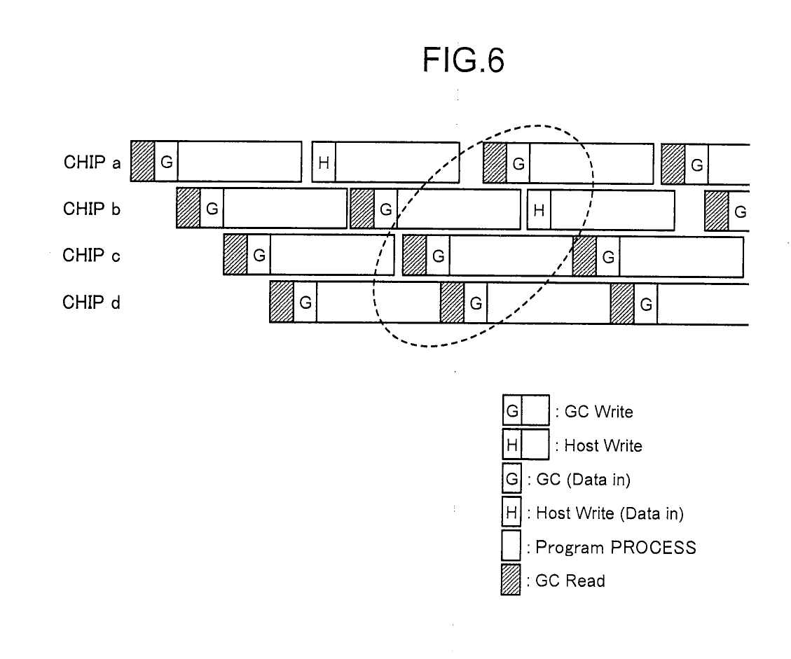

FIG. 6 is a diagram illustrating another example of scheduling for four bank interleaving by the controller 30 in the first embodiment. In FIG. 6, the interleaving operation for GC is performed for one round and the host write is subsequently performed on the chip a. In FIG. 6, when the data-in of the host write for the chip a is completed, data for the host write to the chips b, c, and d cannot be prepared. Accordingly, the use of the write is switched from the host write to GC. GC is then performed on the chip b, and further on the chips c, d, and a. Accordingly, GC is performed for one round. In FIG. 6, when the data-in of GC for the chip a is completed, one page worth of data for the host write can be prepared. Accordingly, the host write is performed on the chip b after GC on the chip a.

In FIG. 6, when the data-in of the host write for the chip b is completed, data for the host write to the chips c and d cannot be prepared. Accordingly, the target of the write is switched from the host write to GC. GC is then performed on the chip c, and further on the chips d, a, and b. Accordingly, GC is performed for one round.

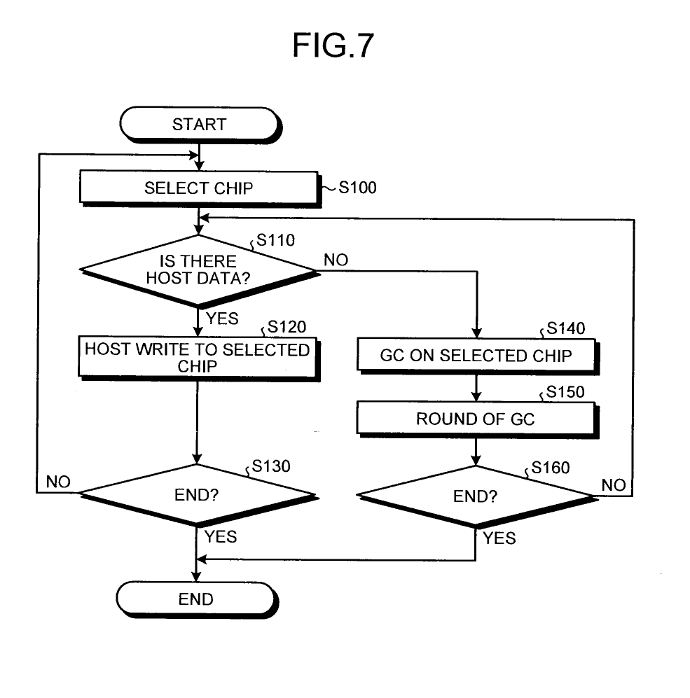

FIG. 7 illustrates a control procedure for bank interleaving (chip interleaving) performed by the controller 30. In this case, it is assumed that chip interleaving is performed on four memory chips a to d. Chip interleaving is assumed to be performed in the order of the chips a, b, c, and d. The controller 30 selects a chip on which bank interleaving is performed from the plurality of memory chips a to d (step S100). Next, the controller 30 determines whether or not host data necessary to be written to the selected chip has been prepared (step S110).

When the host data has been prepared as a result of the determination of step S110, the controller 30 executes the host write to the selected chip (step S120). When the host write is completed, the controller 30 determines whether or not the write control on the NAND 10 is completed (step S130). If not, the controller 30 shifts the procedure to step S100 and selects the next chip.

When the host data has not been prepared as a result of the determination of step S110, the controller 30 executes GC on the selected chip (step S140). As illustrated in FIG. 6, if the currently selected chip is the chip b and host data cannot be prepared at this point in time, the controller 30 executes GC on the chip b. The controller then executes GC on the chips c, d, and a to execute a round of GC (step S150). When GC is completed, it is determined whether or not the write control on the NAND 10 is completed (step S160). If not, the procedure is shifted to step 5110 and whether or not there is host data is determined.

When there is host data as a result of the determination of step S110, the controller 30 executes the host write on the selected chip (step S120). When there is no host data as a result of the determination of step S110, the controller 30 executes a round of GC with the selected chip as the first chip (steps S140 and S150). In the first embodiment, such processing is performed.

In the memory system 100, the above-mentioned inter-chip error correcting code (inter-chip ECC) is adopted to save a memory chip from failure. When the interleaving operation illustrated in FIG. 5 is performed, the inter-chip error correcting code is formed in units of page data distributed to the chips a, b, c, and d. In FIG. 5, with respect to the write data of GC written in the order of the chips a, b, c, and d, for example, data is stored in the chips a to c, and code data is stored in the chip d. On the other hand, with respect to the write data of GC written in the order of the chips c, d, a, and b, for example, data is stored in the chips c, d, and a, and code data is stored in the chip b. Moreover, with respect to the data of the host writes written in the order of the chips a, b, c, and d, for example, data is stored in the chips a to c, and code data is stored in the chip d.

In FIG. 5, with respect to the write data of GC written in the order of the chips c, d, a, and b, for example, the writes are performed in a different order from the normal chip order a, b, c, and d. Accordingly, the order of writes between chips is required to identify the order of data at the time of code creation. Hence, the controller 30 manages the order of writes between chips, for example, with respect to GC data written in an order different from the normal one. A target whose write order between chips is managed by the controller 30 may be only GC data written in a different order from the normal one, all the write data of GC, or all the write data including the host write and GC. Moreover, the write order between chips managed by the controller 30 may be managed by the controller 30 in a table as management information together with a data address, or managed by being added to the data itself.

In this manner, in the first embodiment, if data for the host write cannot be prepared, a write for GC is executed to a memory chip to which the unprepared data is scheduled to be written. Writes for GC are subsequently executed to n memory chips in a predetermined order at least for one round. Hence, in the first embodiment, the wasted time of chip interleaving can be reduced to increase the write speed. Moreover, an increase in the buffer amount for buffering host data can be suppressed.

### Second Embodiment

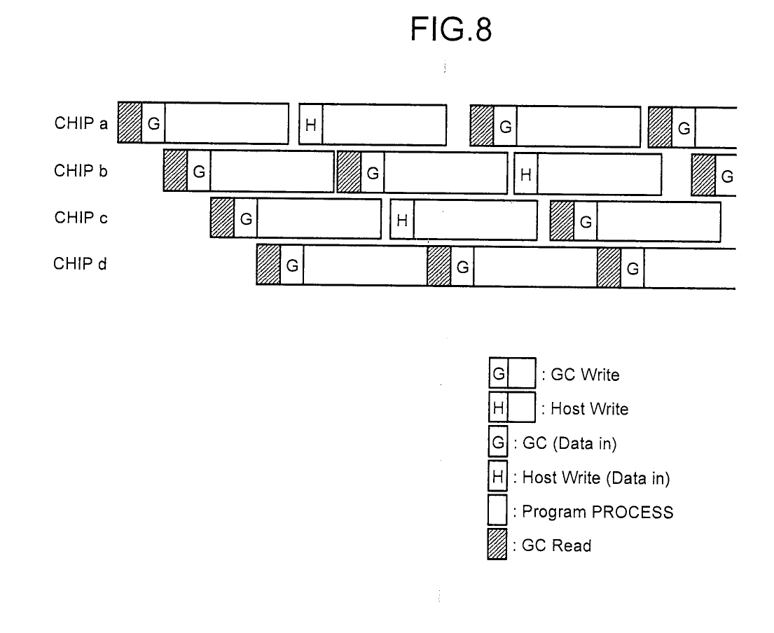

FIG. 8 illustrates scheduling in a second embodiment. In the scheduling of the first embodiment, it is set such that if the host write is switched to GC, GC is performed on memory chips for one round. In contrast, in the second embodiment, it is set such that GC is switched to the host write if host data can be prepared before GC is performed on memory chips for one round after the host write is switched to GC.

In FIG. 8, the host write is performed on the chip a after the interleaving operation for GC is performed for one round. In FIG. 8, when the data-in of the host write for the chip a is completed, data for the host write to the chip b cannot be prepared. Accordingly, the use of the write is switched from the host write to GC. GC is then performed on the chip b. When the data-in of GC for the chip b is completed, one page of data for the host write can be prepared. Accordingly, the host write is then performed on the chip c. After the data-in of the host write for the chip c ends, one page worth of data for the host write cannot be prepared. Accordingly, the use of the write is switched from the host write to GC to perform GC on the chips d and a. When GC for the chip a is completed, one page of data for the host write can be prepared. Accordingly, the host write is then performed on the chip b. After that, one page worth of data for the host write cannot be prepared. Accordingly, GC is performed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a non-volatile memory including n (n≧2) memory chips, the memory chips sharing a bus, each of the memory chips including a plurality of blocks, each of the blocks being a unit of data erasing, each of the blocks including a plurality of memory cells; and
a controller configured to execute a first write and a second write by executing chip interleaving for a plurality of cycles, the chip interleaving being executed by accessing the n memory chips in a predetermined order, the first write being for writing data received from a host to the memory chip, the second write being for collecting valid data read from a first block of the memory chip and writing the valid data to a second block of the memory chip, wherein
the controller is configured to execute, partway through one cycle, the chip interleaving for the first write, and execute the chip interleaving for the second write to the n memory chips from a memory chip next in turn to a memory chip to which the first write was executed last, to the memory chip to which the first write was executed last.

2. The memory system according to claim 1, wherein, when the n memory chips of data for executing the first write in a predetermined unit is unable to be reserved, the controller is configured to execute, partway through one cycle, the chip interleaving for the first write, and execute the chip interleaving for the second write to the n memory chips from a memory chip next in turn to a memory chip to which the first write was executed last, to the memory chip to which the first write was executed last.

3. The memory system according to claim 2, wherein, when the data for executing the first write in the predetermined unit is reserved, when the second write to the n memory chips is completed, the controller is configured to execute the first write to a memory chip next in turn to a memory chip to which the second write was executed last.

4. The memory system according to claim 3, wherein, when the data for executing the first write in the predetermined unit is unable to be reserved, when the second write to the n memory chips is completed, the controller is further configured to execute the second write to the n memory chips to which the second write has been executed.

5. The memory system according to claim 1, wherein the controller is configured to manage information identifying an order in which the second write has been executed.

6. The memory system according to claim 5, wherein the controller is configured to add the information to data to which the second write is to be executed.

7. A memory controller configured to control a non-volatile memory including n (n≧2) memory chips, the memory chips sharing a bus, each of the memory chips including a plurality of blocks, each of the blocks being a unit of data erasing, each of the blocks including a plurality of memory cells, the memory controller comprising:
a controller configured to execute a first write and a second write by executing chip interleaving for a plurality of cycles, the chip interleaving being executed by accessing the n memory chips in a predetermined order, the first write being for writing data received from a host to the memory chip, the second write being for collecting valid data read from a first block of the memory chip and writing the valid data to a second block of the memory chip, wherein
the controller is configured to execute, partway through one cycle, the chip interleaving for the first write, and execute the chip interleaving for the second write to the n memory chips from a memory chip next in turn to a memory chip to which the first write was executed last, to the memory chip to which the first write was executed last.

8. The memory controller according to claim 7, wherein when the n memory chips of data for executing the first write in a predetermined unit is unable to be reserved, the controller is configured to execute, partway through one cycle, the chip interleaving for the first write, and execute the chip interleaving for the second write to the n memory chips from a memory chip next in turn to a memory chip to which the first write was executed last, to the memory chip to which the first write was executed last.

9. The memory controller according to claim 8, wherein, when the data for executing the first write in the predetermined unit is reserved, when the second write to the n memory chips is completed, the controller is configured to execute the first write to a memory chip next in turn to a memory chip to which the second write was executed last.

10. The memory controller according to claim 9, wherein, when the data for executing the first write in the predetermined unit is unable to be reserved, when the second write to the n memory chips is completed, the controller is further configured to execute the second write to the n memory chips to which the second write has been executed.

11. The memory controller according to claim 7, wherein the controller is configured to manage information identifying an order in which the second write has been executed.

12. The memory controller according to claim 11, wherein the controller is configured to add the information to data to which the second write is to be executed.

13. A control method of a non-volatile memory including n (n≧2) memory chips, the memory chips sharing a bus, each of the memory chips including a plurality of blocks, each of the blocks being a unit of data erasing, each of the blocks including a plurality of memory cells, the control method comprising:
executing a first write and a second write by executing chip interleaving for a plurality of cycles, the chip interleaving being executed by accessing the n memory chips in a predetermined order, the first write being for writing data received from a host to the memory chip, the second write being for collecting valid data read from a first block of the memory chip and writing the valid data to a second block of the memory chip;
executing, partway through one cycle, the chip interleaving for the first write; and
executing the chip interleaving for the second write to the n memory chips from a memory chip next in turn to a memory chip to which the first write was executed last, to the memory chip to which the first write was executed last.

14. The control method according to claim 13, comprising,
when the n memory chips of data for executing the first write in a predetermined unit, is unable to be reserved,
executing, partway through one cycle, the chip interleaving for the first write,
and executing the chip interleaving for the second write to the n memory chips from a memory chip next in turn to a memory chip to which the first write was executed last, to the memory chip to which the first write was executed last.

15. The control method according to claim 14, comprising,
when the data for executing the first write in the predetermined unit is reserved, when the second write to the n memory chips is completed,
executing the first write to a memory chip next in turn to a memory chip to which the second write was executed last.

16. The control method according to claim 15, comprising,
when the data for executing the first write in the predetermined unit is unable to be reserved, when the second write to the n memory chips is completed,
executing the second write to the n memory chips to which the second write has been executed.

17. The control method according to claim 13, comprising managing information identifying an order in which the second write has been executed.

18. The control method according to claim 17, comprising adding the information to data to which the second write is to be executed.
